(19) United States
(12) Patent Application Publication
(10) Pub. No.: US 2022/0076139 A1
(43) Pub. Date: Mar. 10, 2022

(54) MULTI-MODEL ANALYTICS ENGINE FOR ANALYZING REPORTS

(71) Applicant: JPMORGAN CHASE BANK, N.A., New York, NY (US)

(72) Inventors: Andrew F. GOLDBERG, Tenafly, NJ (US); Jonathan M. BAUM, Brooklyn, NY (US); Reshma KHANNA, Dublin, OH (US); Dimple Ashokkumar SADHWANI, Bangalore (IN); Phanindra JAKKAM, West Godavari (IN); Sourabh V. JHA, Bangalore (IN)

(21) Appl. No.: 17/115,609

(22) Filed: Dec. 8, 2020

(30) Foreign Application Priority Data
Sep. 9, 2020 (IN) 202011038851

(51) Int. Cl. G06N 5/00; G06N 20/20; G06N 3/04; G06N 7/00; G06F 40/40

(52) U.S. Cl. CPC G06N 5/003; G06N 20/20; G06F 40/40; G06N 7/005; G06N 3/0445

(57) ABSTRACT

Systems and methods for an automated software solution to evaluate expense reports and provide analytic results. For example, some embodiments combine different analytic models, which, when applied to together, provide a comprehensive analysis of aggregated expense report data. In some embodiments, a multi-model approach may determine whether a target expense report varies from predicted values and whether the user who submitted the target report is an outlier with respect to other users who previously submitted expense reports.

### RELATED APPLICATIONS

This application claims priority to, and the benefit of, Indian Patent Application No. 202011038851, filed Sep. 9, 2020, the disclosure of which is hereby incorporated, by reference, in its entirety.

### BACKGROUND OF THE INVENTION

### 1. Field of the Invention

The present disclosure relates to an automated software solution to evaluate virtually all expense reports and provide recommendations to approving parties.

### 2. Description of the Related Art

The Information Technology (IT) department of an organization is responsible for managing and providing software solutions to allow employees to submit expense reports for approval. The submission and approval process begins with an employee transmitting an expense report to an approving party (e.g., a manager of the employee). The expense report may include one or more line items, where each line item corresponds to an expense incurred by the employee. The approving party may be made up of a hierarchy of approvers who each review the expense report to determine whether it is approved. The employee may be reimbursed upon approval of the submitted expense report.

Expense reports could violate or take advance of company policies at the company's detriment. For example, an employee who is authorized to expense food might not be authorized to expense alcohol. An expense report submitted by this employee might be unapproved if the approving party is diligent but might still be approved at the approving party's oversight. Due to the volume and frequency of expense reports, it may be difficult to meticulously review each expense report. Some organizations may randomly sample a small portion (e.g., 5%) of the expense reports across a company to determine whether expense reports are submitted in compliance with company policies. However, it may be the case that only a small percentage of employees knowingly or unknowingly abuse policies relating to expensing items. As a result, random sampling might not adequate to detect this small percentage of employees.

### SUMMARY OF THE INVENTION

The present disclosure relates to an automated software solution to evaluate virtually all expense reports and provide recommendations to approving parties. For example, some embodiments combine different analytic models, which, when applied together, provide a comprehensive analysis of aggregated expense report data to determine whether a target expense report varies from predicted values and whether the user who submitted the target report is an outlier with respect to other similar users who previously submitted expense reports. In cases where the expense report is found to have no risks the expense reports can be auto approved with no manager approvals.

The analytics engine may run in the background of a preexisting expense submission and approval system. The analytics engine may access a history of expense reports and aggregate them for building different models. The analytics engine may then analyze newly submitted expense reports and generate corresponding analytics reports that inform an approving party on how to proceed. In addition, the analytics engine may generate a results summary to help evaluate and analyze company-wide policies relating to expensing items.

The analytics engine may use multiple models when analyzing an aggregated data set of expense reports. In some embodiments, the analytics engine uses both supervised learning and unsupervised learning models. For example, a supervised learning model may evaluate whether a particular expensed amount significantly varies from a predicted amount. An unsupervised learning model may use unsupervised learning to identify users who are outliers based on past behavior (e.g., behavior related to patterns in expense report submission). Expense reports submitted by outliers should have their expense reports thoroughly reviewed. In addition to artificial intelligence-based models, the analytics engine may concurrently apply data science-based models such as a rule-based model to evaluate expense reports.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a drawing of a networked environment according to various embodiments.

FIG. 2 is a drawing that shows a workflow that may occur in a networked environment according to various embodiments.

FIG. 3 is a drawing that illustrates a supervised learning model that may be implemented in a network environment according to various embodiments.

FIG. 4 is a drawing that illustrates an unsupervised learning model that may be implemented in a network environment according to various embodiments.

FIG. 5 is a flowchart illustrating an example of the functionality of an analytics engine according to various embodiments.

FIG. 6 is a schematic showing an example of an implementation of various embodiments in a computing system.

### DETAILED DESCRIPTION OF PREFERRED EMBODIMENTS

Exemplary embodiments will now be described in order to illustrate various features. The embodiments described herein are not intended to be limiting as to the scope, but rather are intended to provide examples of the components, use, and operation of the invention.

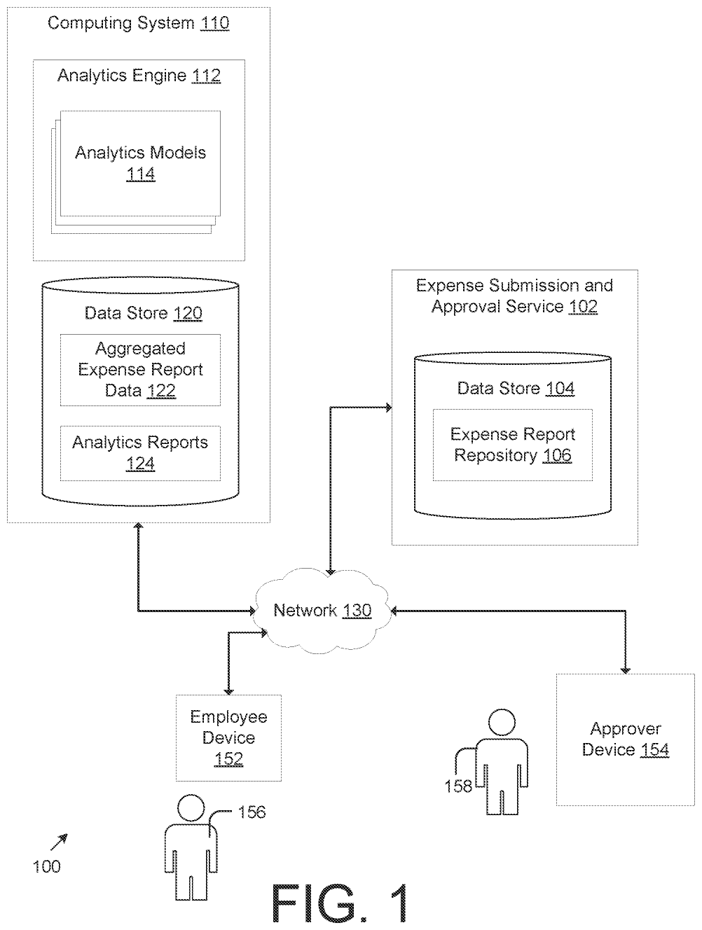

FIG. 1 shows a networked environment 100 according to various embodiments. The networked environment 100 includes an expense submission and approval service 102. The expense submission and approval service 102 may be a software tool that collects expense reports from users, stores them, and sends them to approving parties for approval or denial. The expense submission and approval service 102 may be an end-to-end solution that tracks whether an expense report is approved and transmits the approval status to users. The expense submission and approval service 102 may be a third-party cloud service (e.g., a Software as a Service) used by employees of an organization to generate expense reports and transmit them to approving parties. The expense submission and approval service 102 may allow one or more Application Programming Interfaces (APIs) to allow other software modules to communicate with the expense submission and approval service 102.

The expense submission and approval service 102 may include a data store 104 that includes an expense report repository 106. The expense report repository 106 may include a comprehensive set of expense reports submitted by employees over a period of time. The expense report repository 106 may be queried using a database query or API by other software modules to extract expense reports stored in the data store 104. For example, an external module may submit a query to extract expense reports from the data store 104 using query parameters that define a predetermined period of time, a particular set of users, a particular dollar amount, etc.

The expense submission and approval service 102 may interface with users by generating web documents (e.g., Hypertext Markup Language (HTML) documents, Extensible Markup Language (XML)) and sending them to client devices. A client device receiving web documents may render a web-based interface using a browser or dedicated application to interact with the expense submission and approval service 102. For example, via a web-based interface, users may create and upload expense reports. And, approving parties may receive expense reports and approve/deny them.

The networked environment 100 also includes a computing system 110 that may execute application programs and store various data. The computing system 110 may be implemented as a server installation or any other system providing computing capability. Alternatively, the computing system 110 may employ a plurality of computing devices that may be arranged, for example, in one or more server banks or computer banks or other arrangements. Such computing devices may be located in a single installation or may be distributed among many different geographical locations. For example, the computing system 110 may include a plurality of computing devices that together may comprise a hosted computing resource, a grid computing resource, and/or any other distributed computing arrangement. In some embodiments, the computing system 110 may correspond to an elastic computing resource where the allotted capacity of processing, network, storage, or other computing-related resources may vary over time. The computing system 110 may implement one or more virtual machines that use the resources of the computing system 110 to execute server-side applications.

The computing system 110 may be managed, controlled, or operated by the IT department of an organization. An organization's developers may build applications that execute in the computing system 110. The computing system 110 may include an analytics engine 112. At a high-level, the analytics engine 112 may work in conjunction with the expense submission and approval service 102. For example, the analytics engine 112 may operate in the background by analyzing previously submitted expense reports that have had approval decisions. The analytics engine 112 may also analyze currently recently submitted expense reports with pending approval statuses.

The analytics engine 112 may interface with the expense submission and approval service 102 through one or more APIs, database queries, or other network commands. Network commands that may be made in relation to modules and services included in the analytics engine 112 may be implemented according to different technologies, including, but not limited to, Representational state transfer (REST) technology or Simple Object Access Protocol (SOAP) technology. REST is an architectural style for distributed hypermedia systems. A RESTful API (which may also be referred to as a RESTful web service) is a web service API implemented using HTTP and REST technology. SOAP is a protocol for exchanging information in the context of Web-based services.

The analytics engine 112 may include several analytics models 114. An analytics model 114 may be a module that is configured to receive input and generate an output that comprises an assessment of the input. For example, the output may be metadata, a score, a file, a data log entry, or other data that comprises an analysis of the input. A model includes an algorithm that applies principles of data science or artificial intelligence to assess an input. Data science-based models include statistical models or rule based models that may relatively predictable or deterministic.

Artificial intelligence-based models apply artificial intelligence-based algorithms to analyze an input. Artificial-intelligence based models may include supervised learning or unsupervised learning principles. Supervised learning models use training data to build the model. Training data includes a dataset that is labeled. The label represents how a piece of data in the dataset should be classified. The supervised learning model learns from the labeled dataset to apply new labels to new datasets during run time. For example, the supervised learning model may build a decision tree using the training data to classify new datasets. Supervised learning models include, for example, Naïve Bayes, (k-nearest neighbors) K-NN), support vector machine (SVM), Decision Trees, or Logistic Regression.

Unsupervised machine learning models refer to artificial intelligence models that analyze input data, organize the data (e.g., clustering, grouping, linking data items, etc.), and generate an output that characterizes the way the data is organized. This may involve organizing input data into clusters and/or identifying outliers. Unsupervised learning models include, for example, K-Means, Mean-Shift, density-based spatial clustering applications with noise (DBSCAN), Fuzzy C-Means, or Isolation Forests.

Each analytics model 114 may include executable code that comprises the model's algorithm and configuration data that is stored and used by the model. Depending on the type of analytics model 114, the configuration data may include, for example, training data, cluster data, features, etc. Thus, to build or generate an analytics model 114, the execution code and/or configuration data may be created or updated to specify how the analytics model 114 operates.

The computing system 110 may include a data store 120. The data store 120 may store data, files, executable code, libraries, APIs, configuration data, and other data/executables to allow the application programs of the computing system 110 to execute. For example, the application programs of the computing system 110 may read data from the data store 120, write data to the data store 120, update, delete, or otherwise manipulate data in the data store 120.

The data store 120 may store aggregated expense report data 122 and analytics reports 124. The aggregated expense report data 122 may be generated by accessing expense reports from the expense report repository 106 and combining it as aggregated data. The aggregated expense report data 122 may be generated by processing expense reports by adding metadata or by categorizing the expense reports. For example, the expense reports may be converted into a one or more database tables of records, where each record corresponds to an expense report. In addition, each record may have a field such as, for example, a user ID field. The user ID value in the user ID field may be associated with the user who submitted the corresponding expense report. In addition, each record may relate to other database tables in a relational database structure. Other database tables may refer to the line items in an expense report, where the line item includes fields for a purchase amount, a merchant name, a merchant category, etc. Thus, the aggregated expense report data 122 may represent a set of expense reports organized by database tables, database records, and database fields. The aggregated expense report data 122 may contain the contents of expense reports submitted by multiple users across an organization.

The analytics report 124 may be generated for each newly submitted expense report. The analytics report 124 may then be sent to the approval party responsible for approving the newly submitted expense report. The analytics report 124 may provide information to assist the approving party to make an approval decision. For example, the analytics report 124 may identify an expensed amount (e.g., the amount an employee spent on an item that the employee intends to expense) and a predicted amount (e.g., the amount that the item may historically or typically costs). In addition, the analytics report may indicate an amount of variance that the expensed amount varies from the predicted amount. The analytics report may also indicate whether the user who submitted the expense report is an outlier. An outlier may be an individual who exhibits a behavior that statistically deviates from the population. The behavior may be defined by a feature vector data structure that characterizes how a user has behaved with respect to adhering to or following expense report policies/guidelines.

In some embodiments, in addition to analytics report 124 for specific expense reports, additional analytics report 124 may be generated to provide a high level summary for an organization across multiple users. This may allow the organization to obtain a snapshot of the organization's expense patterns. For example, the analytics report 124 may identify users who are outliers, the number of outliers, or the percentage of outliers of an organization. The analytics report can also include statistics about the number or percentage of expense reports having expensed amounts that significantly varied from predicted amounts.

The computing system 110 is coupled to a network 130. The network 130 may include networks such as the Internet, intranets, extranets, wide area networks (WANs), local area networks (LANs), wired networks, wireless networks, or other suitable networks, etc., or any combination of two or more such networks. The computing system 110 may communicate with the expense submission and approval service 102 as well as a plurality of client devices 152, 154. In this respect, the computing system 110 and various client devices 152, 154 may be arranged in a client-server configuration.

A client device 152, 154 may be a personal computing device, laptop, mobile device, smart phone, tablet, desktop, or other client device. The client device 152, 154 may include a client application such as a browser or dedicated mobile application to communicate with the computing system 110. The computing system 110 may receive requests from the client device 152, 154, and generate responses using a communication protocol such as, for example, Hyper Text Transport Protocol (HTTP).

One type of client device is the employee device 152. The employee device 152 is used by an employee 156. The term employee may refer to an agent, employee, contractor, or other user of the organization. The employee 156 may purchase items such as travel-related items, goods, or services that are potentially reimbursable by the organization. To get reimbursed, the employee 156 may create an expense report that itemizes each item that the employee wishes to expense to the organization. The employee 156 may use the expense submission and approval service 102 to create and transmit the expense report. For example, the employee 156 may manually input each item into a user interface rendered on the employee device 152. The employee may also take a picture of a receipt using a camera phone to capture the details regarding an item. The expense submission and approval service 102 may receive input from the employee device 152 and generate and store an expense report in the data store 104. The expense report may include a user identifier associated with the employee 156 who submitted the expense report.

Another type of client device is the approver device 154. The approver device 154 is operated by an approving party 158. The approving party 158 may include one or more managers, directors, agents, or other individuals who are responsible for reviewing/approving expense reports. The expense submission and approval service 102 may store a reference table that maps the user identifier of an employee 156 to the identifier(s) of the approving party 158. The expense submission and approval service 102 may automatically transmit a newly submitted expense report to the appropriate approver device 154 based on the reference table. The approver device 154 may render a user interface to allow the approving party 158 to review expense reports, approve expense reports, deny expense reports, comment on expense reports, and request follow-ups regarding expense reports. The expense submission and approval service 102 may track this input to determine whether an expense report is approved or denied. Alternately the expense report may have no anomalies and systemically approved by expense submission and approval service 102.

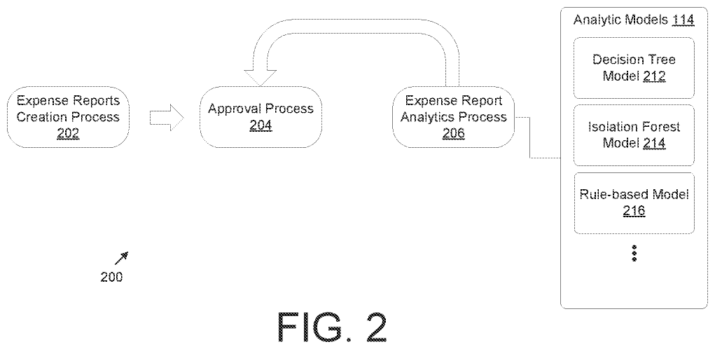

FIG. 2 is a drawing that shows a workflow 200 that may occur in a networked environment according to various embodiments. The workflow 200 may be implemented using various components and systems described with respect to FIG. 1. The workflow 200 begins with an expense report creation process 202. Here, a user (e.g., employee) using an employee device 152 submits an expense report data using the expense submission and approval service 102. The user may provide various inputs such as images of receipts or manual data entry of items purchased. The expense submission and approval service 102 may assemble the inputs into a formatted expense report and store it in an expense report repository 106.

Next in the workflow 200, is the approval process 204. The expense submission and approval service 102 may automatically transmit the expense report to the approver device(s) 154 of the approving party 158. The approving party may take action with respect to the expense report such as, for example, approving or denying the expense report. The expense submission and approval service 102 may track the approval status of submitted expense reports.

The workflow 200 also includes an expense report analytics process 206. The expense report analytics process 206 may be implemented by the analytics engine 112. The expense report analytics process 206 may run in parallel with other processes in the workflow 200 and/or may run in the background. The expense report analytics process 206 may aggregate a set of expense reports to generate aggregated expense report data 122. The aggregated expense report data 122 includes expensed items associated with various user identifiers. The expensed items may include data such as, for example, a date of purchase, a purchase amount, a merchant associated with the purchase of the item, a category or classification of the item purchased, a category or classification of the merchant, or other data associated with the purchase of the item. The expense report analytics process 206 may use the aggregated expense report data 122 to generate or otherwise configure different analytic models 114.

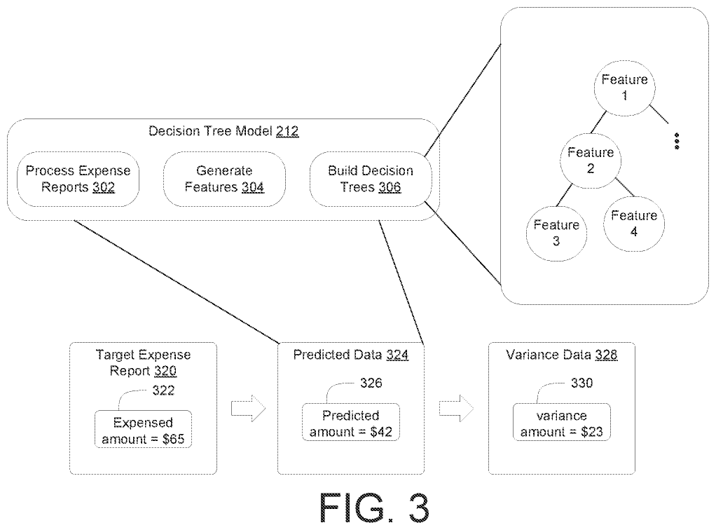

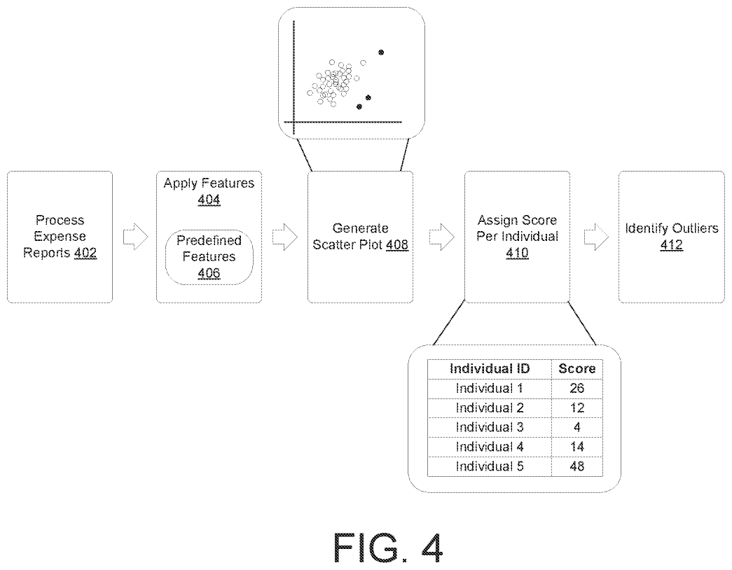

The analytic models 114 may include, for example, artificial intelligence-based models and data science-based models. The artificial intelligence-based models include, for example, a decision tree model 212 (discussed in greater detail with respect to FIG. 3), an isolation forest model 214 (discussed in greater detail with respect to FIG. 4), and potentially other artificial intelligence-based models.

The data science-based models may include, for example, a rule-based model 216. The rule-based model may apply a set of hardcoded rules to input data. the set of hardcoded rules may be audit rules used to automatically audit an expense report. For example, the audit rules may include a block list of merchants, a block list of categories, a threshold number of cash claims, a merchant category mismatch, or a number of expenses that exceed a threshold. A block list of merchants may be a list of merchants that are not allowed. In other words, an employee 156 may not be allowed to expense items that are purchased from merchants on the block list. A block list of categories may include a category of merchants or a category of items sold by merchants. Categories of merchants that may be on the block list include, for example, bars, adult entertainment establishments, entertainment service providers, etc. Categories of items that may be on the block list include, for example, alcohol, admission tickets for sporting events, etc. An audit rule pertaining to a threshold number of cash claims may also be part of the rule-based model 216. In this embodiment, some organizations may allow reimbursements for items paid for in cash (e.g., up to a predefined amount). The audit rule may count the number and monetary value of cash claims submitted over a period of time and compare it to a threshold. In this respect, this rule checks for whether an employee is submitting a large number of cash claims for a given period of time. Another audit rule may check for a merchant category mismatch. The rule may compare the category of the item purchased to the category of the merchant to determine whether there is a mismatch. For example, purchasing airfare from a travel company may result in no mismatch but purchasing alcohol from a travel company may be a mismatch. Another audit rule may track the number of expenses with respect to a threshold. This may include the number of items purchased over a period of time or a total amount purchased over a period of time.

The various analytic models 114 may execute in serial or in parallel. Some analytic models 114 may be applied to newly submitted expense reports while others analyze aggregated expense report data as a whole. The expense report analytics process 206 may generate an analytics report 124 based on applying various analytic models 114 to a target expense report. In some embodiments, the analytics report 124 may be provided to the approving party 158 as part of the approval process 204.

FIG. 3 is a drawing that illustrates a supervised learning model that may be implemented in a network environment according to various embodiments. Specifically, FIG. 3 shows a decision tree model 212 that may be part of an analytics engine 112. FIG. 3 shows how to generate and execute a decision tree model 212 according to various embodiments.

For example, generating the decision tree model 212 includes processing expense reports 302. As explained above, expense reports may be aggregated into aggregated expense report data 122. The aggregated expense report data 122 may organize the expense reports using database fields. The aggregated expense report data 122 may encompass expense reports submitted by a wide variety of users having respective user identifiers. The aggregated expense report data 122 may potentially include hundreds of data attributes that describe expensed items.

Generating the decision tree model 212 may involve generating features 304. A feature is a quantifiable property or characteristic of data that is subject to analysis. A feature vector is a series of different feature values that describe a piece of data. Features may be generated by analyzing the aggregated expense report data 122 using, for example, natural language processing (NLP).

In some embodiments, the aggregated expense report data 122 is processed in advance of a natural language process (e.g., natural language pre-processing). For example, a text pre-process operation may be performed to remove specific text from the unstructured text contained in the aggregated expense report data 122. The natural language pre-processing may use one or more regular expressions containing predefined text. Predefined text may include specific words or phrases that do not meaningfully provide context. For example, the pre-processing may remove common words that do not provide significant context (e.g., “stop words”) such as the words “a”, “the”, “in”, “an”, etc. The pre-processor may apply a Lemmatization function to the case text to convert each word into a predefined root word or stein of each word. For example, the word “having” may be converted to the stein word “have.”

Once the data is pre-processed, NLP may be applied to identify a set of features. Some features include, for example, location, a job function code, or a line of business. These features are based on the contents and metadata associated with expense reports as well as any unstructured text or fields within the expense reports. While the original data may be characterized by hundreds of attributes, the features that are generated by applying NLP may be fewer than a hundred.

Once the features are generated, the decision tree model 212 is generated by building decision trees 306. The generation of features boost the decision trees by adding additional complexity and nuances to the tress structure to obtain more accurate results. In a decision tree structure, different decision trees may correspond to different features. Decision trees are linked to form complex chains of decision trees. There may be hundreds of decision trees that are automatically generated based on the features.

Once the decision tree model 212 is generated, it may be applied to a target expense report in run time. For example, a target expense report 320 is received. The target expense report 320 may include a line item for an item that was purchased. The target expense report 320 may include an expensed amount 322. The expensed amount may be a dollar amount that an employee 156 has paid for an item. The target expense report 320 may also include other information such as, for example, information about the item purchased, information about the merchant who sold the item, information about the time, place, and location of the transaction for the item, the user identifier for the user who submitted the target expense report 320, or other data relating to the purchase of the item.

Next, the decision tree model 212 is applied to the target expense report 320. The target expense report 320 may input information contained in the expense report target expense report 320 in the decision trees. For example, the information discussed about relating to the item, merchant, and circumstances around the transaction may be inputted into the decision tree model 212. After executing the decision tree model 212, the decision tree model 212 may generate predicted data 324. Predicted data 324 may include a predicted amount 326 relating the item identified in the target expense report 320.

By way of example, the target expense report 320 may include an expense for a lunch for four people in Atlanta, Ga. in the zip code of 30318. Moreover, the lunch was at a chain restaurant that sells sandwiches. The user who submitted the expense is part of the sales team of the organization. The expensed amount 322 has a dollar value of $65. Based on this contextual data, the decision tree model predicts that under these circumstances the dollar amount should be $42. That is, based on the decision tree model 212, a lunch for four people in Atlanta, Ga. in the zip code of 30318 at a chain restaurant that sells sandwiches attended by an employee in the sales team of the organization, should have a predicted amount 326 of $42.

To determine the predicted amount 326, the decision tree model 212 may analyze the aggregated expense report data 122 comprising a wide range of expense reports and generate features. The features may be, city, zip code, type of merchant, the number of attendees, the time of day (e.g., lunch time versus dimmer time), the job code associated with the user who submitted the target expense report 320, or potentially other features. These features are used to boost or otherwise enhance the decision tree. The specific details around a transaction are analyzed using the boosted decision tree to generate the predicted amount 326.

After the predicted amount 326 is determined, variance data 328 may be generated. Variance data indicates the difference between the expensed amount 322 and the predicted amount 326. The variance data 328 may be a qualitative value such as “high variance,” low variance,” or “negligible variance.” The variance data 328 may also include a variance amount 330 that quantitatively represents the difference between the expensed amount 322 and the predicted amount 326. The variance data 328 may be inserted into an analytics report 124 pertaining to the corresponding target expense report 320. In this respect, an approving party 158 may review the variance data 328 when determining whether to approve or deny the target expense report 320.

FIG. 4 is a drawing that illustrates an unsupervised learning model that may be implemented in a network environment according to various embodiments. Specifically, FIG. 4 shows an isolation forest model 214 that may be part of an analytics engine 112. FIG. 4 shows how to generate and execute an isolation forest model 214 according to various embodiments.

For example, generating the isolation forest model 214 includes processing expense reports 402. To process expense reports, expense reports may be aggregated into aggregated expense report data 122. The aggregated expense report data 122 may organize the expense reports using database fields. The aggregated expense report data 122 may encompass expense reports submitted by a wide variety of users having respective user identifiers. The aggregated expense report data 122 may potentially include information about the various users who submitted expense reports over a defined window of time.

Generating the isolation forest model 214 may involve applying a set of features 404 to the aggregated expense report data 122. The isolation forest model 214 may analyze different portions of the aggregated expense report data 122 than other models, such as, for example, the decision tree model 212. The isolation forest model 214 may receive a different set of features that may be predefined features 406. This set of features are applied to the aggregated expense report data 122 to generate a scatter plot 408. The set of features may be behavioral features associated with the users who submitted expense reports. There may be a dozen or few dozen behavioral features that characterize the users. In this respect, the isolation forest uses features specific to user behavior. A decision tree model, on the other hand, may use different features specific to transactions.

The behavioral features used in the isolation forest model 214 may characterize the degree in which users expense gifts, expense conference or training related items, expense items in relation to per diem limits, expense items using credit cards that are not issued by the organization, expense cash claims, expense items purchased outside of business hours (e.g., on the weekend), expense overtime meals, expense items that are outside typical categories (e.g., meals and travel), expense items that mismatch with merchant categories, expense items from items or merchants on a block list, seek cash advances, expense items in specific categories (e.g., travel, communications, lodging, meals, entertainment, travel), etc.

The generated scatterplot may plot each user identifier in the feature vector space. For example, the dimension of the scatter plot may correspond to the length of the feature vector (e.g., the number of elements in the feature vector). When using feature vectors that correspond to behavioral features, users associated with relatively extreme behavioral features may be identified. This provides a cumulative approach to identify users who submit expense reports that are likely to push the boundaries of company policies and guidelines. Users with relatively extreme behavioral features may be likely to continue to submit expense reports that are questionable.

The isolation forest model 214 may assign an individual score to each individual user identifier 410. For example, the feature vector scatter plot may be analyzed to find a mean or median feature vector that characterizes a large population of users. To determine the score, a distance may be calculated between each feature vector that is plotted and the mean or median feature vector. The score represents the degree in which an individual associated with a user identifier deviates from the average. The score is based on the distance and may be expressed in terms of a standard deviation from the average feature vector.

The isolation forest model 214 may identify outliers 412. For example, the isolation forest model 214 may rank or sort each user identifier by the corresponding score. The score may correspond to the distance a user is away from the average behavior in a feature vector space that characterizes user behavior. Scores that exceed a threshold are deemed outliers. In some embodiments, the threshold is defined in terms of a min or max score value. In some embodiments, the threshold is defined in terms of the number of standard deviations away from a mean/median score. Data indicating whether a user is an outlier may be inserted into an analytics report 124.

In some embodiments, the isolation forest model 214 is not applied to specific target expense reports 320, which may be the case for the decision tree model 212 discussed with respect to FIG. 3. The isolation forest model 214 may be periodically executed in response to new expense reports being received. In this respect, the isolation forest model 214 tracks an organization's user behavior over time as new expense reports may or may not be submitted by specific users. Average user behavior may change over time and this change is tracked as the isolation forest model is periodically updated as new expense reports are received.

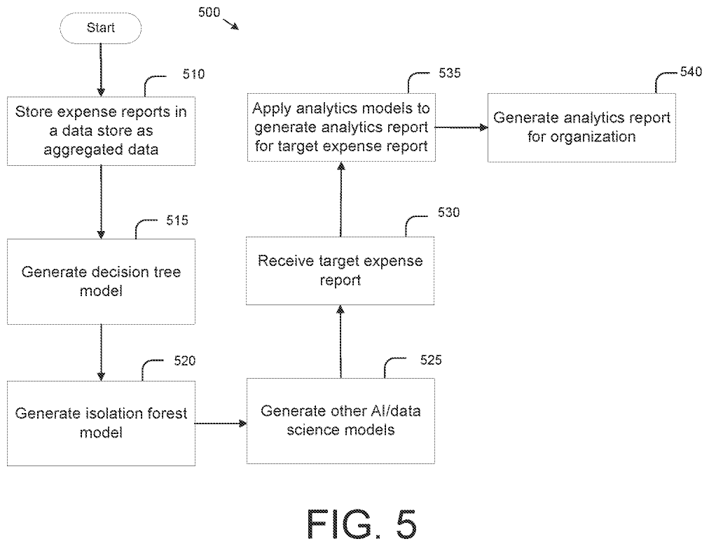

FIG. 5 is a flowchart illustrating an example of the functionality of an analytics engine according to various embodiments. It is understood that the flowchart of FIG. 5 provides an illustrative example of the many different types of functional arrangements that may be employed to implement the operation of the portion of a computing system as described herein. The flowchart of FIG. 5 may also be viewed as depicting an example of a method 500 implemented in the networked environment 100 of FIG. 1 according to one or more embodiments. FIG. 5 may represent the functionality of an analytics engine, such as, for example, the analytics engine 112 of FIG. 1.

At item 510, the computing system stores a plurality of expense reports in a data store as aggregated expense report data. The computing system may extract expense reports from an expense submission and approval system and move them to a data store. The computing system may add metadata or otherwise organize the extracted expense reports when aggregating it.

At item 515, the computing system generates a decision tree model. An embodiment of generating the decision tree model is described with respect to FIG. 3. The decision tree model may be a first analytics model that is generated. The decision tree model is an example of a supervised learning artificial intelligence model. For example, the decision tree model may be trained using training data that configures the decision tree model. The decision tree model may be updated over time as new training data is used.

In addition, the decision tree model may be generated by determining a set of features. For example, when generating the decision tree model, the aggregated expense report data may be processed. This includes applying a natural language process to the aggregated expense report data to generate a set of features. These features may define how an expense report should be characterized. In this respect, each expense report may be quantified or described as having a particular signature, where the signature is a feature vector. The feature vector of a particular expense report is a series of feature values for different features in the set of features. Training data may be generated by applying labels (e.g., classifications) to different expense reports. This creates an association between a feature vector and a label. This training data configures the decision tree model to classify new expense reports. The decision tree model may be configured to determine a variance value for an expensed amount in a target expense report a set of features.

At item 520, the computing system generates an isolation forest model. An embodiment of generating the isolation forest model is described with respect to FIG. 4. The isolation forest model may be a second analytics model that is generated. The isolation forest model is an example of an unsupervised learning artificial intelligence model. For example, the isolation forest model may be generated from analyzing the aggregated expense report data. The isolation forest may be configured to determine whether a user associated with the user identifier is an outlier using a different set of features. The different set of features may be defined based on characterizations of user behavior with respect to how they submit expense reports. The totality of these features for a particular user may provide a holistic view regarding whether the user is likely to abuse policies and guidelines for expense report submission.

In some embodiments, a respective score may be generated and associated with each user identifier contained in the aggregated expense report data. The score may correspond to the distance a user is away from the average behavior of a group of users represented in the aggregated expense report data. An outlier may be identified by applying a threshold to the respective score associated with user identifier of the user.

In some embodiments, the isolation forest model is periodically updated. For example, the isolation forest model may be generated may be generated for a predefined window of time (e.g., the most recent data within the last year). In this embodiment, the isolation forest model filters the aggregated expense report data to the most recent year to ensure that a recent history of current behavior is used to generate this model. This way, old behavior patterns may be excluded from the analysis. This may also allow the analytics model to track newer data as guidelines and policies may change over time.

At item 525, the computing system may generate other artificial intelligence or data science-based models. A data science-based model may include a model that applies a set of audit rules. As a result, multiple analytic models may be generated in parallel or in serial and used to provide analytics on expense report submissions.

At item 530, the computing system may receive a target expense report. The computing system may interface with an expense submission and approval system to obtain the target expense report. The target expense report may be a newly submitted expense report that has a pending approval status.

At item 535, the computing system may apply different analytics models to generate an analytics report for target expense report. For example, the computing system may apply a first analytics model to determine a variance value for an expensed amount in the target expense report. The computing system may apply a second analytics model to determine whether the user who submitted the target expense report is an outlier in terms of behavior.

In some embodiments, the analytics report may include an indication of the variance value. In some embodiments, the analytics report may include an indication of whether the user is an outlier. In some embodiments, the computing system transmits the analytics report to a predetermined approving party. In some embodiments, the computing system transmits the analytics report to the predetermined approving party in response to the user being an outlier.

At item 540, the computing system may generate an additional analytics report for the organization. For example, the additional analytics report may summarize the expense report submissions across multiple employees of the organization. For example, the additional analytics report may identify the employees who are outliers, the number of outliers, or the percentage of outliers of an organization. The additional analytics report can also include statistics about the number or percentage of expense reports having expensed amounts that significantly varied from predicted amounts.

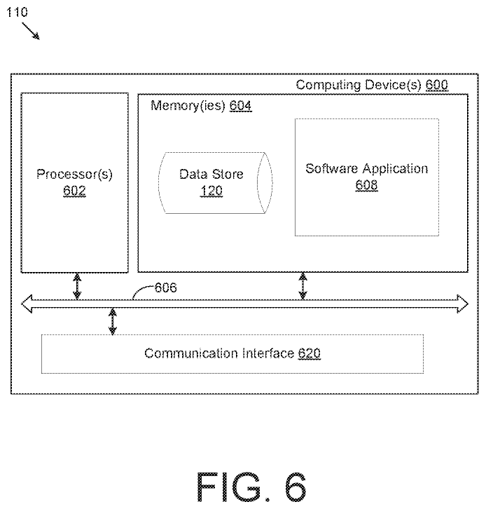

FIG. 6 is a schematic showing an example of an implementation of various embodiments in a computing system 110. The computing system 110 may include one or more computing devices 600 with distributed hardware and software to implement the functionality of the computing system 110.

The computing device 600 includes at least one processor circuit, for example, having a processor 602 and memory 604, both of which are coupled to a local interface 606 or bus. Stored in the memory 604 are both data and several components that are executable by the processor 602. For example, the memory 604 may include the data store 120 as well as other memory components that store data or executables.

Also stored in the memory 604 and executable by the processor 602 is a software application 608. The software application 608 may embody the functionality described in FIGS. 2-5. The software application 608 may include the analytics engine 112 of FIG. 1.

It is understood that there may be other applications that are stored in the memory 604 and are executable by the processor 602 as can be appreciated. Where any component discussed herein is implemented in the form of software, any one of a number of programming languages and environments may be employed, such as, for example, C, C++, C#, Objective C, Java®, JavaScript®, Perl, PHP, Visual Basic®, Python®, Ruby, ABAP on SAP BI, or other programming languages and environments.

Several software components are stored in the memory 604 and are executable by the processor 602. In this respect, the term “executable” means a program file that is in a form that can ultimately be run by the processor 602. Examples of executable programs may be, for example, a compiled program that can be translated into machine code in a format that can be loaded into a random access portion of the memory 604 and run by the processor 602, source code that may be expressed in proper format such as object code that is capable of being loaded into a random access portion of the memory 604 and executed by the processor 602, or source code that may be interpreted by another executable program to generate instructions in a random access portion of the memory 604 to be executed by the processor 602, etc. An executable program may be stored in any portion or component of the memory 604 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 604 is defined herein as including both volatile and nonvolatile memory and data storage components. Volatile components are those that do not retain data values upon loss of power. Nonvolatile components are those that retain data upon a loss of power. Thus, the memory 604 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RANI may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 602 may represent multiple processors 602 and/or multiple processor cores and the memory 604 may represent multiple memories 604 that operate in parallel processing circuits, respectively. In such a case, the local interface 606 may be an appropriate network that facilitates communication between any two of the multiple processors 602, between any processor 602 and any of the memories 604, or between any two of the memories 604, etc. The local interface 606 may couple to additional systems such as the communication interface 620 to coordinate communication with remote systems.

Although components described herein may be embodied in software or code executed by hardware as discussed above, as an alternative, the same may also be embodied in dedicated hardware or a combination of software/general purpose hardware and dedicated hardware or a public cloud platform. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc.

The flowchart discussed above show the functionality and operation of an implementation of components within a system such as a software application 608 or other software. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system, such as a processor 602 in a computer system or other system. The machine code may be converted from the source code, etc. If embodied in hardware, each block may represent a circuit or a number of interconnected circuits to implement the specified logical function(s).

Although the flowchart shows a specific order of execution, it is understood that the order of execution may differ from that which is depicted. For example, the order of execution of two or more boxes may be scrambled relative to the order shown. Also, two or more boxes shown in succession may be executed concurrently or with partial concurrence. Further, in some embodiments, one or more of the boxes may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The components carrying out the operations of the flowchart may also comprise software or code that can be embodied in any non-transitory computer-readable medium for use by or in connection with an instruction execution system such as, for example, a processor 602 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any program or application described herein, including the software application 608, may be implemented and structured in a variety of ways. For example, one or more applications described may be implemented as modules or components of a single application. Further, one or more applications described herein may be executed in shared or separate computing devices or a combination thereof. Additionally, it is understood that terms such as “application,” “service,” “system,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A computer-implemented method comprising:
storing a plurality of expense reports in a data store as aggregated data;
generating a first analytics model based on the aggregated data, the first analytics model configured to determine a variance value for an expensed amount in a target expense report using a first set of features, the target expense report comprising the expensed amount and a user identifier;
generating a second analytics model based on the aggregated data, the second analytics model configured to determine whether a user associated with the user identifier is an outlier using a second set of features; and
generating an analytics report for the target expense report, the analytics report comprising an indication for the variance value and an indication of whether the user is an outlier.

2. The method of claim 1, wherein the first analytics model comprises a supervised learning artificial intelligence model.

3. The method of claim 2, wherein the second analytics model comprises an unsupervised learning artificial intelligence model.

4. The method of claim 1, wherein the first analytics model comprises a decision tree model and the second analytics model comprises an isolation forest model.

5. The method of claim 1, wherein generating the first analytics model comprises applying a natural language process to the aggregated data to generate the first set of features.

6. The method of claim 1, wherein the first set of features comprises at least one of a location, a job function code, or a line of business.

7. The method of claim 1, wherein generating the second analytics model comprises associating a respective score to each user identifier in the aggregated data.

8. The method of claim 7, wherein the second analytics model is configured to determine whether the user associated with the user identifier is an outlier by applying a threshold to the respective score associated with user identifier of the user.

9. The method of claim 1, further comprising generating a third analytics model comprising a set of audit rules, wherein the analytics report is generated by applying the first analytics model, second analytics model, and third analytics model to the target expense report.

10. The method of claim 9, wherein the set of audit rules comprises a block list of merchants, a block list of categories, a threshold number of cash claims, a merchant category mismatch, or a number of expenses that exceed a threshold.

11. The method of claim 9, wherein the set of audit rules comprises a block list of merchants, a block list of categories, a threshold number of cash claims, a merchant category mismatch, or a number of expenses that exceed a threshold.

12. An apparatus comprising:
a data store configured to store a plurality of expense reports as aggregated data;
a processor; and
a memory that stores a plurality of instructions of an analytics engine, the analytics engine comprising:
a first analytics model based on the aggregated data, the first analytics model configured to determine a variance value for an expensed amount in a target expense report using a first set of features, the target expense report comprising the expensed amount and a user identifier; and
a second analytics model based on the aggregated data, the second analytics model configured to determine whether a user associated with the user identifier is an outlier using a second set of features;
wherein the analytics engine is configured to transmit an analytics report for the target expense report to a recipient, the analytic report comprising an indication for the variance value and an indication of whether the user is an outlier.

13. The apparatus of claim 12, wherein the second analytics model comprises an unsupervised learning artificial intelligence model.

14. The apparatus of claim 13, wherein the first analytics model comprises a supervised learning artificial intelligence model.

15. The apparatus of claim 12, wherein the first analytics model comprises a decision tree model and the second analytics model comprises an isolation forest model.

16. The apparatus of claim 12, wherein the first analytics model comprises applying a natural language process to the aggregated data to generate the first set of features.

17. The apparatus of claim 12, wherein the first set of features comprises at least one of a location, a job function code, or a line of business.

18. The apparatus of claim 12, wherein the second analytics model is configured to associate a respective score to each user identifier in the aggregated data.

19. The apparatus of claim 12, wherein the second analytics model is configured to determine whether the user associated with the user identifier is an outlier by applying a threshold to the respective score associated with user identifier of the user.

20. The apparatus of claim 12, wherein the analytics engine comprises a third analytics model comprising a set of audit rules, wherein the analytics report is generated by applying the first analytics model, second analytics model, and third analytics model to the target expense report.
